(19) United States
(12) Patent Application Publication
(10) Pub. No.: US 2019/0172122 A1
(43) Pub. Date: Jun. 6, 2019

(54) ECOMMERCE ORDER OPTIMIZATION TOOL

(71) Applicant: Quality Logo Products, Inc., Aurora, IL (US)

(72) Inventors: Michael Wenger, Oswego, IL (US); Bret Bonnet, North Aurora, IL (US)

(21) Appl. No.: 16/271,053

(22) Filed: Feb. 8, 2019

Related U.S. Application Data
(63) Continuation-in-part of application No. 14/229,768, filed on Mar. 28, 2014.
Application No. 14/229,768 is a continuation-in-part of application No. 13/960,783, filed on Aug. 6, 2013, now abandoned.
Application No. 13/960,783 is a continuation of application No. 13/169,455, filed on Jun. 27, 2011, now Pat. No. 8,577,738.

(51) Int. Cl. G06Q 30/06

(52) U.S. Cl. CPC G06Q 30/0633; G06Q 30/0627; G06Q 30/0601

(57) ABSTRACT

An ecommerce cost optimization system includes: a display including information identifying an item; a quantity selection tool; a delivery location selection tool; an optimized offer presentation tool that provides at least one optimized option through the display component, wherein the at least one optimized option is optimized based on the selected delivery date and the selected delivery location; and an order placement tool to place an order from amongst the options provided by the optimized offer presentation tool. A method of providing optimized offer for non-stock item transactions through an ecommerce application includes receiving a user selection including a selected delivery date and a selected delivery location and determining an optimized offer based on analysis of the possible combinations of a production schedule and a delivery schedule for the selected quantity and delivery location.

### CROSS-REFERENCE TO RELATED APPLICATIONS

This application is a continuation-in-part U.S. patent application Ser. No. 14/229,768 filed Mar. 28, 2014, which is a continuation-in-part of U.S. patent application Ser. No. 13/960,783 filed Aug. 6, 2013, which is a continuation of U.S. patent application Ser. No. 13/169,455, filed Jun. 27, 2011.

### BACKGROUND OF THE INVENTION

The present invention relates generally to an ecommerce order optimization tool based on quantity ordered, delivery location and, optionally, delivery date requested. Particularly, the present invention relates to a system and method for optimizing the combination of production schedule and shipping method to minimize price for a given delivery date for customized promotional products and other custom or non-stock goods.

Ecommerce tools typically provide a user with a selection of a quantity of a given product and, often, a shipping method. These systems lack efficient tools for allowing a customer and vendor to optimize the production schedule and delivery schedule to deliver non-stock goods to the customer on a selected delivery date for an optimized price.

For example, the typical ecommerce site for ordering custom goods allows users to select amongst a plurality of order options related to production schedule (e.g., standard production, rush production, etc.) and delivery methods (e.g., ground shipping, two day shipping, overnight shipping, etc.), from which a price is calculated. While useful, these systems do not allow for efficient optimization of the production and delivery schedules and further do not provide an easy mechanism for evaluating alternate combinations.

Accordingly, there is a need for a system, method, and product that provide a customer and vendor to optimize the production schedule and delivery schedule to deliver non-stock goods to the customer to a selected location on a selected delivery date for an optimal price. Such a system could be expressed in the following way: for example, a product might have 20 or more different shipping and production combos available, giving the user 20 options for which they must make selections. The inventive system would instead present only the best options (to wit, the lowest cost per additional delivery day “gained” vs. the original/default delivery option (to wit, the least expensive combination)).

### BRIEF SUMMARY OF THE INVENTION

The subject matter provided herein addresses these issues by providing a system and method for efficiently optimizing the combination of production schedule and delivery schedule to deliver customized promotional products and other custom and non-stock goods at an optimized price.

As used herein, production schedule is the time it takes for a vendor to produce or acquire a non-stock item (e.g., custom-made, custom-ordered, etc.). Typically, non-stock items may be acquired on any of a variety of production schedules (e.g., standard production, rush production, etc.), with the shorter the production schedule, the more costly the production. For example, a vendor may have two possible production schedules for a particular item; a standard seven day production schedule at a standard price and a rush two day production schedule at a premium price.

As used herein, delivery schedule is the time it takes for a vendor, such as a courier, to deliver an item to a customer. Typically delivery may occur using any of a number of various delivery schedules (e.g., standard ground, two day shipping, overnight shipping, etc.). Similar to production schedule, it is often the case that the quicker the delivery schedule, the more costly the delivery.

One of the advantages presented by the present subject matter is that it provides a tool for assisting customers appropriately balance the cost of production schedule and delivery schedule to optimize their cost. Importantly, the tool helps the customer overcome the natural bias to choose a longer production schedule and shorter delivery schedule, particularly since it is typically more expensive to expedite shipping than it is to shorten the production schedule.

One embodiment of the present invention is an ecommerce tool for optimizing the delivered price of a non-stock item placed through an automated order placement system. The ecommerce tool includes an order placement mechanism providing, and, optionally, a quantity selection tool, a delivery location selection tool, a delivery date selection tool and an order placement tool. By allowing the customer to select the quantity, delivery location and delivery date and allowing the vendor(s) to control the production and delivery schedule, an optimized price may be offered to the customer. In addition, the ecommerce tool may be adapted to provide alternatives to the user selection based on alternative values of delivery date and/or order quantity. It will be understood that certain proprietary methods of the present invention will include such elements as the automatic selection of the best value quantity on page load. This is because some suppliers will not realize built in savings such as they may sell 100 units for $150 when in another selection the purchaser could buy 200 units for $145. The tool would make accommodations for such savings an automatically choose the best deal. In other embodiments, the best/optimal price is selected and there is no option to select an alternative delivery date and no such tool exists in such an embodiment.

A further example of the present invention is a method of optimizing the delivered price of a non-stock item placed through an automated order placement system. The method may include the steps of: providing an order placement mechanism including a quantity selection tool, a delivery location selection tool, a delivery date selection tool and an order placement tool; receiving optionally, a user selection including a quantity and/or delivery date; providing the user with an optimized cost for the user selection; optionally, further providing the user with at least one alternative selection based on an optimized cost using an altered quantity or production schedule and/or altered delivery date; and receiving a user selected order from amongst the user selection and one or more alternative selections.

The first two examples provided use a combination of quantity, delivery location and delivery date in the price optimization. However, it is contemplated that alternative embodiments of the system may use only two of the three values, for example, quantity and delivery location. In such an example, the system may return an optimized price based on all delivery dates available for the combination of quantity and shipping location. Several alternatives may be provided to the user illustrating optimized totals for various possible delivery dates, as well as alternate quantities. For example, an optimized price based on quantity and delivery location may include three separate price offerings based on three different delivery dates, as well as include additional price offerings based on increasing or decreasing the quantity of the order to lower the unit cost.

The ecommerce tool may be embodied in any number of electronic systems, for example, websites, mobile applications, etc. Although the examples used herein focus on website applications, it is understood that website are merely one example of systems in which the ecommerce tool may be embodied. The systems comprise computers having a micro-processor, read only memory, random access memory, communications means, such as LAN and Wi-Fi devices and one or more memory and storage locations in one or more hard drives within the computers. Additionally, the computers have software for communications to a network, such as the Internet, input/output components (such as a keyboard and mouse or touch screens) and video viewing means to be able to view and access the network and thereby the system of the present invention.

In one example, the ecommerce tool is provided in a website on a network such as the Internet. The website includes a quantity selection tool (e.g., input field to receive the user's selection for the order quantity), a delivery location selection tool (e.g., input field for receiving the user's selection for the order delivery location), and an optional delivery date selection tool (e.g., input field to receive the user's selection for the order delivery date). The user inputs the selections for the quantity, delivery location (it is important to note that the delivery date is automatically selected by the system in making an optimized order, but that persons having ordinary skill in the art will realize that in some embodiments the delivery date of an item could be one other element in the optimization of the system, without departing from the novel scope of the present invention) and the ecommerce tool uses that information, along with cost information related to the production schedule and delivery schedule. In other words, when the user selects the number of units to purchase, where the units are to be delivered and the date by which the user wishes to possess the units, the ecommerce tool will optimize the combination of production schedule and delivery schedule to provide an optimized cost to the user. The user may then place the order through the order placement tool (e.g., input mechanism for confirming an order).

In yet another example, the system may include a selection tool associated with optimizing a price based on the purchase total cost, instead of the individual item prices. Further, the user selection may include a maximum budget price that the user is willing to pay for the selected goods, optionally, taking into account the proposed delivery dates. The system may provide various options for the user based on the input maximum budget including the quantity and delivery dates that are available at or below the budget price.

The system is capable of producing a price optimized cost to the user based at least one user selection including quantity, delivery location, delivery date, and a setup fee associated with one or more items selected for purchase. For example, the user might be able to purchase 300 pens for $1 each plus $8 in setup fees. They might also be able to purchase 600 pens for $.50 with no setup fee. Since it actually costs LESS to buy MORE, the system will default the quantity of the product on page load to 600 instead of 300 in order to better advantage the user (buyer).

In another example, the website may further provide the user with one or more alternative selections based on an optimized cost using an altered quantity and/or altered delivery date. For example, the user may select 100 units for delivery in 7 days for $250 and the ecommerce tool may provide a first alternative of 100 units for delivery in 10 days for $225, a second alternative for 150 units for delivery in 7 days for $325 and a third alternative of 150 units for delivery in 10 days for $300. The user may then select from amongst the user selection and one or more alternative selections or may enter a new user selection and receive additional alternative selections.

In one embodiment, an ecommerce cost optimization system includes: a display component for displaying information identifying an item; a delivery date selection tool responsive to a user input to select a delivery date; a delivery location selection tool responsive to a user input to set a delivery locations; an optimized offer presentation tool responsive to the optional delivery date selection tool and the delivery location selection tool that provides at least one optimized option through the display component, wherein the at least one optimized option is optimized based on selected delivery location; and an order placement tool responsive to a user input to place an order from amongst the options provided by the optimized offer presentation tool. The at least one optimized option may be optimized by comparing the possible combinations of production schedule and delivery schedule to determine an optimized option. The optimized offer presentation tool provides at least one price optimized option for each a plurality of items.

The ecommerce cost optimization system may include a quantity selection tool responsive to a user input to select a quantity of an item, wherein the optimized offer presentation tool is responsive to the quantity selection tool in providing at least one price optimized option.

Further, it is contemplated that the system and method provided herein may be adapted such that the customer enters a fixed budget into the order placement mechanism and one or more optimized offers are provided based on variations in quantity, delivery date and/or delivery location. For example, the customer may submit a fixed budget of $500 and the system and/or method may provide one or more optimized prices offering a quantity of product, delivered to a location by a given delivery date for a price equal to the fixed budget.

The ecommerce cost optimization system may further include a delivery date selection tool responsive to a user input to select a delivery date. In such an embodiment, the optimized offer presentation tool may be responsive to the quantity selection tool, the delivery location selection tool and the delivery date selection tool to provide at least one price optimized option through the display component, wherein the at least one price optimized option is optimized based on the possible production schedules of the selected quantity and the possible delivery schedules to the selected delivery location.

The ecommerce cost optimization system may further include an alternative offer presentation tool that provides, through the display component, at least one alternative option to the optimized option and further wherein the order placement tool is responsive to a user input to place an order from amongst the options provided by the optimized offer presentation tool and the alternative offer presentation tool. The alternative option is based on a different delivery location than the optimized option, or a later delivery date than the optimized option, or another alternative combination.

An embodiment of a method of providing optimized offer for non-stock item transactions through an ecommerce application, includes the steps of: providing an order placement mechanism including a delivery date selection tool, a delivery location selection tool and an order placement tool; receiving a user selection including a selected delivery date and a selected delivery location; determining an optimized offer based on analysis of the possible combinations of a production schedule and a delivery schedule for the selected delivery date and delivery location; and providing the user with at least one optimized offer for each a plurality of items based on the selected delivery date and the selected delivery location. Finally the method may further include the step of receiving a user selected order from amongst the user selection and one or more alternative selections. In a preferred embodiment the delivery location is automatically selected by the computer, using “cookies” or other methods, determining by itself the location of the user and using that location automatically as the delivery location.

The optimized offer may be optimized based on budget, price or delivery date. The order placement mechanism may further include providing a quantity selection tool through which a user selection further includes a selected quantity of items that may be received. The step of determining an optimized offer may then be further based on the selected quantity.

The method may further including the step of providing at least one alternative option to the optimized option. The alternative option may be based on a different delivery location, on a different delivery date, on production time and/or on delivery time or another alternative combination.

The system in a preferred embodiment of the present invention is an ecommerce cost optimization system for agilely delivering customized goods and includes one or more computers configured with a display component for displaying information identifying an item for purchase in quantity. A display component is provided, responsive to a user input for ordering customization of the item and then selecting the quantity of customized items desired. Additionally, a delivery location selection tool responsive to a user input to set at least one selected delivery location is provided as well as a delivery date selection tool which is also responsive to a user input, to set at least one selected delivery date.

The system includes an optimized offer presentation tool responsive to the delivery date selection tool and the delivery location selection tool, that, automatically in response to the selected delivery date, the quantity of items selected, the customization ordered and the selected delivery location, provides at least one price optimized option through the display component, wherein the at least one price optimized option is automatically selected from at least one combinations of one or more item customization, quantity, production schedules and manipulations of the production schedules, courier delivery schedules and one or more delivery options. Wherein, each of the combinations created meets the selected delivery date and the selected delivery location, and wherein the optimized offer presentation tool provides at least one price optimized option for each of a plurality of items selected for customization. The order placement tool is responsive to the user input to place an order from among the at least one price optimized option provided by the optimized offer presentation tool.

The ecommerce cost optimization system further comprising a quantity selection tool responsive to a user input to select a quantity of an item, wherein the optimized offer presentation tool is responsive to the quantity selection tool in providing at least one price optimized option.

The ecommerce cost optimization system further includes an alternative offer presentation tool that provides, through the display component, at least one alternative option to the at least one price optimized option and further wherein the order placement tool is responsive to a user input to place an order from amongst the at least one price optimized option and the at least one alternative option.

The ecommerce cost optimization system described can include at least one alternative option based on a different delivery location compared to the selected delivery location; and/or wherein the at least one alternative option includes an alternative option based on a later delivery date than the selected delivery date.

The invention provides a method of providing an optimized offer for customized-goods transactions through an ecommerce application embodied on a computer-readable medium, the application being executed by at least one computer, including the steps of providing a component for identifying an item for customization and being responsive to a user input for ordering customization of the item and then selecting the quantity of customized items desired, the component undertaking to check inventory and determine time and options for customization so as to create customization information. Then providing an order placement mechanism, including a delivery date selection tool, a delivery location selection tool, and an order placement tool and receiving a user selection including a selected delivery date and a selected delivery location and customization information. From this then, the method can automatically, in response to receiving the selected delivery date, the customization information and selected delivery location, determine, by an optimized offer presentation tool, a price and date optimized offer, all based on analysis of all possible combinations of a production schedule and courier delivery schedules, for the plurality of items to be delivered to the selected delivery location. The method then provides the user with at least one price optimized offer based on the selected delivery date and selected delivery location.

In an embodiment, the method includes at least one price optimized offer provided for each of a plurality of quantities of an item ordered for customization. The method can further including the step of providing at least one alternative option to the at least one price optimized offer including the instance wherein the at least one alternative option is based on a different delivery location than the selected delivery location. Alternatively, the option can be based on a later delivery date compared to the selected delivery date. The method can, in some embodiments, further include the step of receiving a user selected order from among the at least one price optimized offer and the at least one alternative option.

It is further contemplated that in some embodiments of the system and method, the quantity of item may be an additional variable. This may be useful, for example, when the customer has a required quantity but is flexible as to the item itself. Accordingly, in that scenario, varying the quantity, in combination with the production schedule and delivery schedule may provide the optimal order for the customer.

In a preferred embodiment of the system, there are in the computers used hard drives and means to store information and rapidly access that information, additionally there are means to store various files and then later compare the files to select better options within the systems. For example, the database of delivery times and locations from various couriers can be stored therein and compared with one another. On time performance data and discount data for quantity and yearly order customer loyalty data can be stored and used to determine the best choice for delivery time, place and costs.

It is therefore an advantage of the invention provided herein to provide a product, system, and method that assists a consumer, shopping in an ecommerce system, with optimizing the costs to purchase a custom product.

It is another advantage of the invention provided herein to optimize and reduce the cost for a vendor of an ecommerce system to fulfill an order.

It is yet another advantage of the invention provided herein to provide a vendor, operating an ecommerce system, with a system, method, and product to optimize the combination of production and delivery of an order placed through the system.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an example of ecommerce price optimization tool for non-stock goods.

FIG. 2 illustrates the ecommerce tool of FIG. 1, in response to a user's entry of quantity, delivery location and delivery date, wherein the ecommerce tool provides an alternative quantity and delivery date combination.

FIG. 3 is a flow chart illustrating a method of optimizing the price of a non-stock order based on user inputs of quantity, delivery location and delivery date and further based on production schedule costs and delivery schedule costs.

FIG. 4 illustrates an example of the ecommerce tool, in response to a user's entry of a delivery location and delivery date, wherein the ecommerce tool provides optimized offers of various quantities of various products that match the delivery location and date combination.

FIG. 5 is a schematic representation of a computer and computer network used in the method of the present invention.

FIG. 6 illustrates the ecommerce tool of FIG. 1 with the choice of more than one alternative options, in response to a user's entry of quantity, delivery location and delivery date, wherein the ecommerce tool provides an alternative quantity and delivery date combination.

### DETAILED DESCRIPTION OF THE INVENTION

A preferred embodiment of the present invention is a cost optimization system suitable for use in an ecommerce system. For purposes of illustration, the preferred embodiments described herein are shown with respect to an ecommerce website (herein referred to as the Vendor Website) offered by a custom products vendor (here referred to as Vendor), which serves as an exemplary ecommerce website; however it is thought to be understood that the principles set forth herein may be applied to any suitable ecommerce tool, whether embodied in a website, a mobile application or any other electronic tools, not simply just variations of the Internet based websites primarily described herein. The system, a preferred embodiment described and shown herein, is described herein and in all corresponding figures with reference number 10.

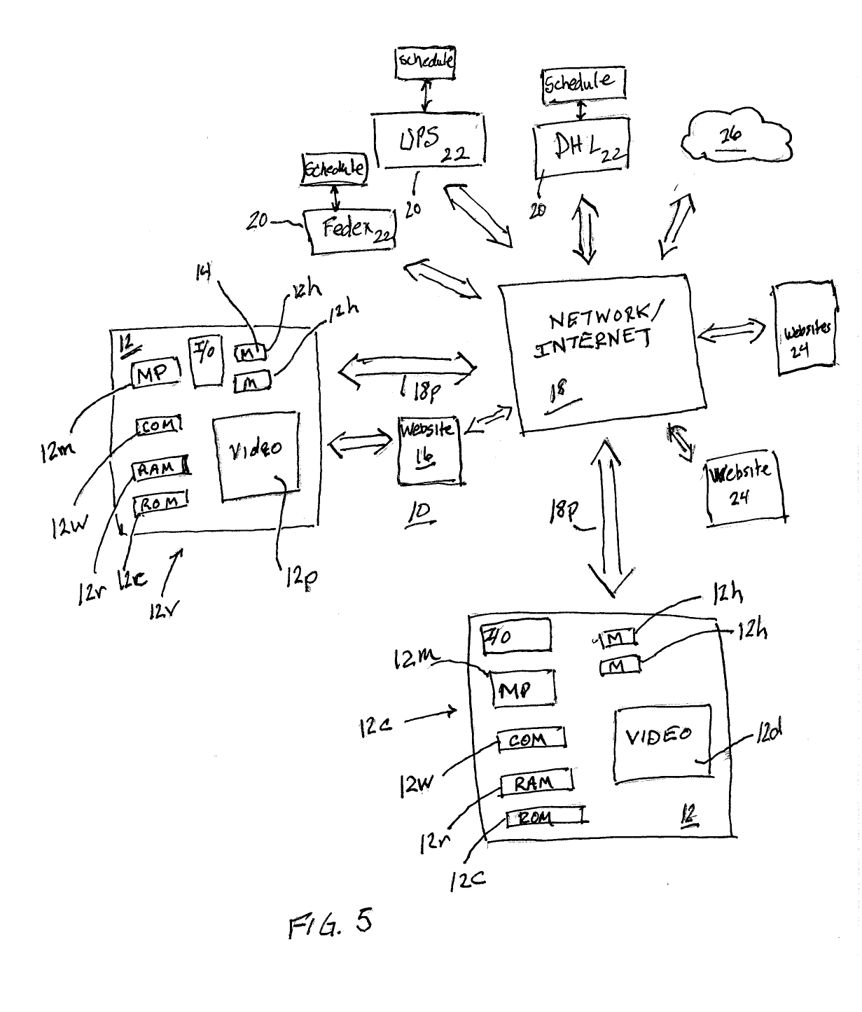

The system 10 may be implemented with at least one computer 12 programmed to support the functions of the system 10 described herein and shown in FIG. 5. In some implementations of the present system 10, more than one computer 12 may be used, where each computer 12 is programmed to support the functions described herein. Such computer(s) may be general purpose computers, such as a desktop computer utilized by a customer wishing to access the website of an ecommerce vendor, where the customer seeks to purchase a specific quantity of a product that is to be delivered by a specific date. However, it is contemplated that any suitable computer may be used in the present system 10, where any suitable computer includes any computer that is capable of being programmed to support functions of the present system 10. Such computers would include at least a microprocessor 12m, one or more storage location within one or more hard drive 12h, a video monitor or other screen 12p, communication means 12w, such as a Wi-Fi and/or a LAN connection, as known to persons having skill in the art, and one or more units each of random access memory and read only memory 12r. Such computers include, but are not limited to, desktop computers, laptop computers, netbooks, cellular phones, smart phones, PDAs, and the like. Further, the present system 10 is not limited to a particular operating system used by any such computer, nor by a particular programming language used to program the computer to necessary to support the functions of the present system 10.

Generally, and as shown in FIG. 5, the present system 10 is contemplated to be used on one or more computers 12, utilized by a user of the present system 10, in communication with one or more computers 12 operated for an ecommerce website 16 implementing an ecommerce system 10. Communication between the two computers preferably occurs via the Internet 18, but it is contemplated that such communication may occur in any suitable manner using any suitable means for communication. Such means for communication by the two computers may, for example, occur via a local-area network (LAN), wide-area network (WAN), virtual private network (VPN), cellular network, Ethernet connection, USB connection, Bluetooth™, or any other suitable communication structure generally shown as network 18 in FIG. 5. The precise method of communication used between the various computers is not intended to be limiting, nor is the communication protocol used by the various computers. The present invention is limited only by the claims presented herein, and not by exemplary functionality or hardware described herein.

The functions described herein with respect to system 10 are supported by two programmed computers 12 (see FIG. 5). One computer (herein referred to as Customer Computer) 12c is programmed to allow a user (herein referred to as Customer) to use invention embodied in system 10, which includes the Vendor's ecommerce system (herein referred to as Vendor System) 14 located in a memory 12m of one or more vendor's computer 12v. The Vendor System 14 provides the necessary ecommerce functions to support the Vendor Website 16. The other computer (herein referred to as Vendor Computer) 12v is programmed to provide the functions for Vendor Website 16 used by the Customer to access the Vendor System 14. The two computers, the Customer Computer 12c and the Vendor Computer 12v are operable to communicate with one another via the internet 18, utilizing known internet communication protocols 18p. Their communication with one another is facilitated by each computer 12, which supports access to the Vendor Website 16, where the Vendor Computer 12v provides the Customer Computer 12c with information and functionality for accessing the Vendor System 14, and the Customer Computer 12c provides the Vendor Computer 12v with instructions and information for accessing the Vendor System 14. The Customer Computer 12c is operably programmed to display and provide access to the Vendor Website 16, where the Customer Computer displays the information from the Vendor's Website in a browser (e.g., Firefox or Internet Explorer), well-known in the art of computer programming applications, which is a computer program application that provides access to view and control access to a website. The browser contains a browser screen 12d, which serves as the means by which Vendor Website 16 is presented. In some embodiments, a cloud storage 26 is employed to provide extra data management and accessibility wherever necessary, as is known to persons having ordinary skill in the art.

It will be seen in FIG. 5 that in addition to the Vendor Website 18, the websites 20 of any number of couriers 22 are also available through the network 18 and can be accessed by and through Vendor Computer 12v, such that the Vendor Website 18 can, in real time, review and update delivery times and costs as needed to provide the best cost estimates to the user of system 11. Additionally, it is contemplated that due to the customers and vendor accessing the timing and billing element of the courier websites 20, the vendor 12 can always secure the best prices and times for delivery. Additionally, such courier data (for each courier available) as good-customer discounts, on-time delivery performance and other logistics can be recorded and placed in the memory 12m locations of both the vendor computer 12v and customer computer 12c, to provide the users with the best possible choice of delivery times and costs to better refine the purchase decision. It is contemplated that the method could employ the customer's courier information if the customer has better costs with particular customers such that delivery is based on the customer information to better serve the customer.

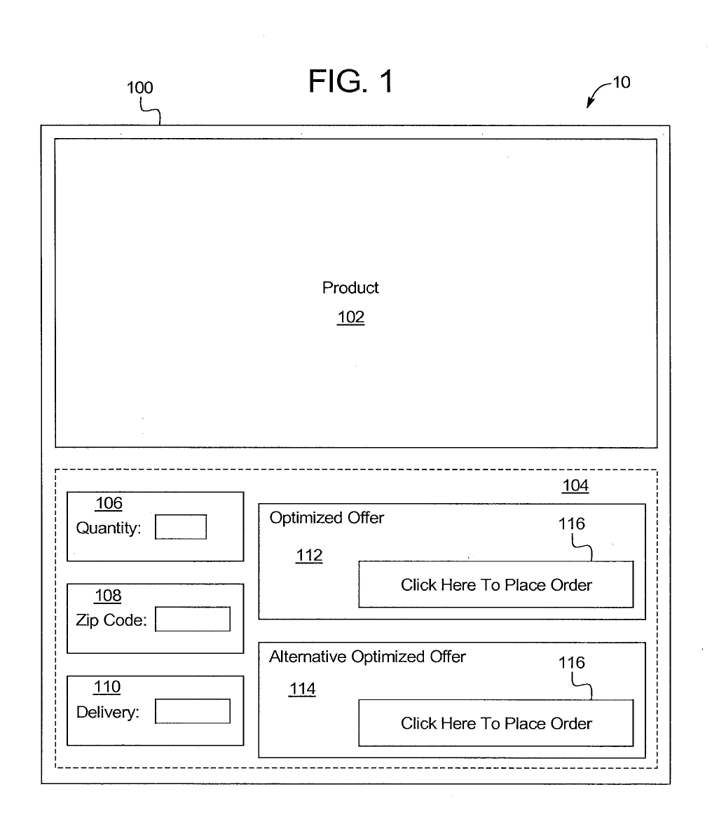

FIGS. 1, 2 and 6 each represent a browser screen in accordance with the preferred embodiment of the present invention, where each is a representation of a browser screen displayed by the Customer Computer in the system 10. FIG. 1 shows an Internet browser screen 100 representing a preferred embodiment of the system 10. Turning now to FIG. 1, the Internet browser screen 100 includes a display for a selected product 102 offered for sale by the Vendor. The product 102 may represent any physical, tangible consumer product, particularly custom made or other non-stock items. The image in FIG. 1 represents a screen shot of a first browser screen 100 displaying the product 102 offered for sale by the Vendor.

In this example, the Internet browser screen 100 includes the product 102 selected by the Customer. In the example shown in FIG. 1, the Internet browser screen 100 provides an order placement mechanism 104 including a quantity selection tool 106, a delivery location selection tool 108, a delivery date selection tool 110, an optimized offer presentation tool 112, an alternative offer presentation tool 114 and an order placement tool 116. The controls shown and described in the system 10 shown with respect to FIGS. 1, 2 and 6 serve as one example of a website based embodiment of the system 10. It is know there are numerous variations in which the system 10 may be embodied.

The quantity selection tool 106 accepts an input value from the Customer representing the quantity desired for the selected product. The quantity selection tool 106 may be any form of quantity selection tool 106, whether a text input field, a drop down menu quantity selector, a sliding quantity selector, etc.

The delivery location selection tool 108 accepts an input value from the Customer representing the destination of the delivery location. In one example, the delivery location selection tool 108 uses the zip code of the delivery destination. In another example, the complete shipping address is required. Accordingly, the delivery location selection tool 108 may be adapted to provide the appropriate interface for entering the required information.

The delivery date selection tool 110 provides an input control that allows the Customer to specify the date by which the Customer is to receive delivery of the selected order. In the embodiment shown, the delivery date selection tool 110 uses a calendar through which the Customer provides a selected date. However, other embodiments may provide other mechanisms for inputting the delivery date information.

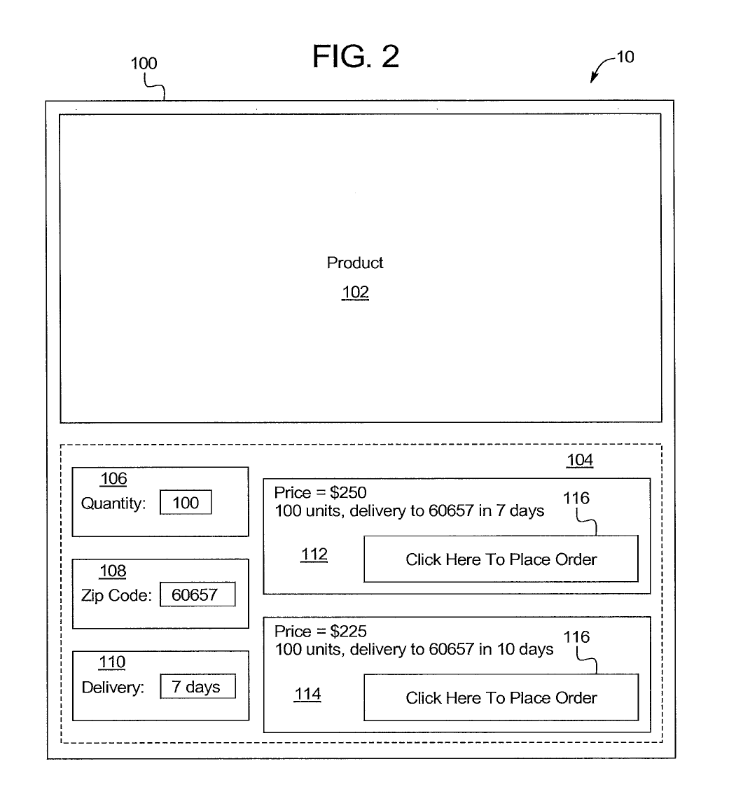

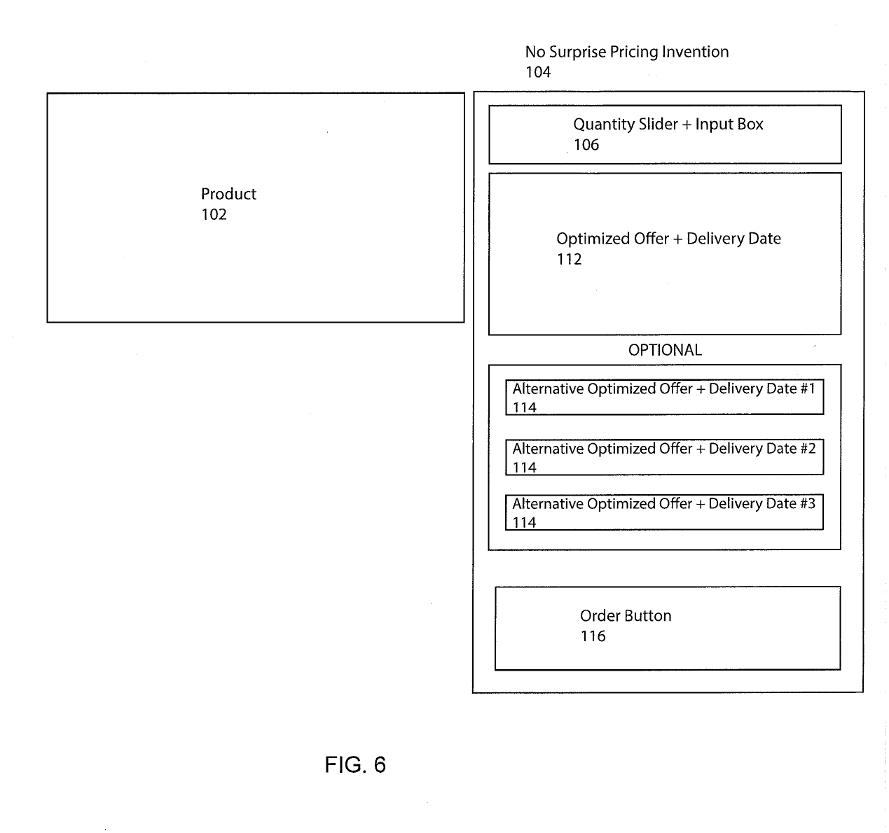

Turning now to FIGS. 2 and 6, after the Customer enters the quantity of product via the quantity selection tool 106, the delivery location via the delivery location selection tool 108 and the delivery date via the delivery date selection tool 110, the Internet browser screen 100 updates to provide an optimized offer to the Customer via the an optimized offer presentation tool 112. As shown in FIGS. 2 and 6, the optimized offer presentation tool 112 presents the Customer with a price for ordering the quantity of product selected for delivery to the specified delivery location by the designated delivery date.

The Customer may then accept the order via the order placement tool 116. In the example shown in FIGS. 1, 2 and 6, the order placement tool 116 is a button selector through which the user may accept the optimized offer presented by the optimized offer presentation tool 112. As with the other tools and mechanisms described herein, the example shown is merely one embodiment of the order placement tool 116 and it is understood that there may be any number of other mechanisms through which the features and functions may be provided to the Customer.

As further shown in FIG. 2, in response to the Customer's entry the quantity of product, the delivery location and the delivery date the alternative offer presentation tool 114 provides additional, alternative, optimized offers to the Customer, any one of which may be selected by the Customer via the order placement tool 116. Additionally, FIG. 6, in response to the Customer's entry the quantity of product, the delivery location and the delivery date the alternative offer presentation tool 114 provides additional, three alternative, optimized offers to the Customer, any one of which may be selected by the Customer via the order placement tool 116. Each of the optimized cost alternatives provides an optimized offer based on some variation of the quantity and/or delivery of the selected product. For example, lower cost offerings may be based on extending the delivery date or lowering the order quantity compared to the information provided by the Customer. Additional alternatives may provide a lower unit cost (even if increasing the total cost) by increasing the order quantity. Each optimized offer alternative may be displayed such that the user may make a selection via the order placement tool 116. With the use of the present system 10, updates to costs and times of shipping can also be available in real time, with the system 10 reaching out to vendor websites to, in real time, query better times and dates based on the size of the order or other parameters.

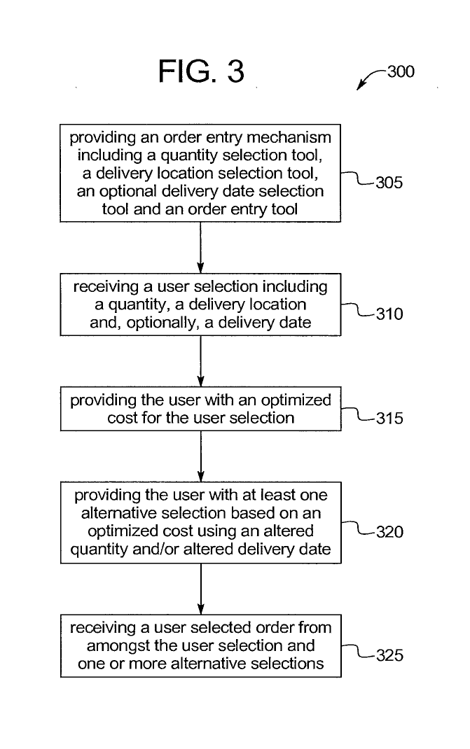

Using the examples of the order placement mechanism 104 provided in FIGS. 1, 2 and 6, FIG. 3 is a flow chart illustrating a method 300 of providing an optimized offer for non-stock item transactions through an ecommerce application (the “method 300”). As shown in FIG. 3, the method 300 includes the steps of: providing an order placement mechanism 104 including a quantity selection tool 106, a delivery location selection tool 108, an optional delivery date selection tool 110 and an order placement tool 116 (step 305); receiving a user selection including a quantity, a delivery location and, optionally, a delivery date (step 310); providing the user with an optimized cost for the user selection (step 315); optionally, further providing the user with at least one alternative selection based on an optimized cost using an altered quantity and/or altered delivery date (step 320); and receiving a user selected order from amongst the user selection and one or more alternative selections (step 325).

In one example, in the first step 305, the Vendor may provide an order placement mechanism 104 including a quantity selection tool 106, a delivery location selection tool 108, a delivery date selection tool 110 and an order placement tool 116 embodied in a website. The website enables the Customer to input the quantity of the product desired through the quantity selection tool 106, the location to which the product is to be delivered via the delivery location selection tool 108 and set the date by which the product is to be delivered via the delivery date selection tool 110.

The Customer selections are then made through the order placement mechanism 104 and communicated to the Vender System in the second step 310. In this example, the user selects 100 units of a given product for delivery to zip code 60657.

Upon receipt of the user selection, the Vender System evaluates the various production schedule options and the various delivery schedule options, including reaching out in real time to material vendors 24 and courier websites, to determine the optimum combination to meet the Customer's order requirements. For example, with a seven day delivery, the production of the product may take six days and the delivery may take one day. Alternatively, the production may be two days and the delivery may take five days. By analyzing the possible combinations of delivery dates, production schedules, delivery schedules and related costs and updating such in real time, an optimized offer may be determined. The optimized offer may then be presented to the Customer via step 315. Step 315 may be accomplished, for example, via an optimized offer presentation tool 112. In this example, the optimized offer may be, for example, delivery of 100 units in seven days for $250.

FIG. 3 further illustrates the optional step of providing the user with at least one alternative selection based on an optimized cost using an altered quantity and/or altered delivery date in step 320. In this example, the first alternative provided by the Vender System may be for the order of 100 units for delivery in ten days for $225. A second alternative offer may be for 150 units for delivery in seven days for $325. A third additional alternative may be for 150 units for delivery in ten days for $300. The alternative optimized offers may be presented, for example, via an alternative offer presentation tool 114. Although only one alternative is shown in FIG. 2 and three alternatives are shown in FIG. 6, it is understood that any number of alternatives may be presented to the Customer. The step (230) of providing the user with at least one alternative selection based on an optimized cost using an altered quantity and/or altered delivery date, may be a useful tool for upselling additional volume of the product 102 to the user by presenting options such as: “buy 20 more and save X %;” or “buy 20 more and save $X.” Similarly, the alternative selection may be useful as a tool for providing a lower cost option to the customer, for example by limiting the quantity or extending the delivery date.

Finally, the Customer may make a selection via the order placement tool 116 which allows the Vender system to receive the user selected order from amongst the user selection and one or more alternative selections in step 325.

The examples provided above with respect to FIGS. 1-3 and 6 use a combination of quantity, delivery location and delivery date in the price optimization process. However, it is contemplated that alternative embodiments of the system 10 may use only two of the three values, for example, quantity and shipping location. In such an example, the system may return an optimized price based on all delivery dates available for the combination of quantity and shipping location provided by the user (i.e., every combination of production schedule and delivery schedule). Several alternatives may be provided to the user illustrating optimized totals for various possible delivery dates, as well as alternate quantities. For example, an optimized price based on quantity and shipping location may include three separate price offerings based on three different delivery dates, as well as include additional price offerings based on increasing the quantity of the order to lower the unit cost.

It is contemplated that through the optimized alternatives provided based on various combination of rush (i.e., expedited) production and/or rush delivery, the tools offered herein will be valuable to both customers and vendors. Further, it is contemplated that the system and method provided herein may be adapted such that the customer enters a fixed budget into the order placement mechanism 104 and one or more optimized offers are provided based on variations in quantity, delivery date and/or delivery location. For example, the customer may submit a fixed budget of $500 and the system and/or method may provide one or more optimized prices offering a quantity of product, delivered to a location by a given delivery date for a price equal to the fixed budget. Additionally, the various combinations for production and delivery can be stored in one or more memory locations 12h in both the vendor computer 12v and the customer computer 12c such that upon the preparation of a combination, the combination is saved therein and marked with a particular recall code, and subsequent combinations are marked and saved as well so that they can be recalled for comparison among each other. The data thus stored is reviewable over the course of time so that the best decision for the proper combination can be made. Additionally, the stored combinations can be reviewed within the system and updated with new data from the network 18 regarding materials 24 and courier rates 22, to provide real time updates. It will be understood that such data, as shipping rates and combinations, may be scraped from the web sited of couriers or shippers and stored in a memory location 12h in the computer 12v for rapid and accurate access to rates which may only be updated rarely. Notice of such rate changes would then prompt the vendor to update the rates stored in memory locations.

It is further contemplated that in some embodiments of the system and method, the delivery location may be an additional variable. This may be useful, for example, when the customer has more than one location (e.g., two corporate offices) and is open to receiving delivery at any location. Accordingly, in that scenario, varying the delivery location, in combination with the production schedule and delivery schedule may provide the optimal order for the customer. Accordingly, the delivery location selection tool 108 may be provided such that a user may specify multiple alternate delivery locations.

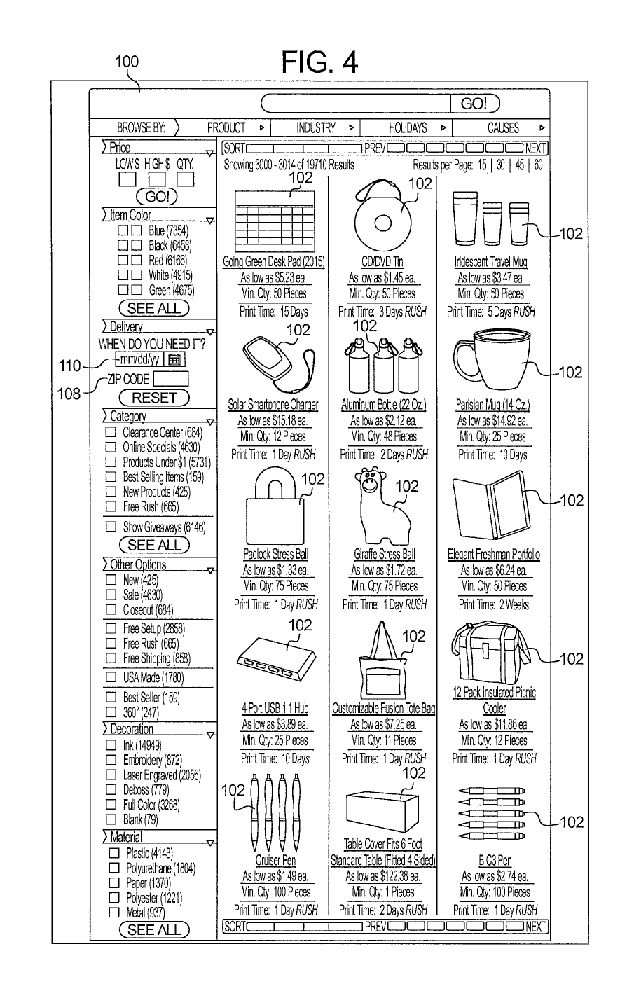

In yet another embodiment of the system and method, the only two user selected search criteria include the delivery date via the delivery date selection tool 110 and delivery location via the deliver location selection tool 108, typically in the form of a zip code, as shown in FIG. 4. This may be useful, for example, when a customer wants to know exactly what products the company can guarantee the customer may receive by the desired delivery date. The default shipping method may be selected by the system or may be specified by the customer.

For example, a customer may select a delivery date by either typing in text or by selecting a date on a virtual calendar displayed by the system. The system will further attempt to auto fill the zip code of the customer based on the customer's IP address. Alternatively, the customer may type in the appropriate zip code for shipment purposes.

Based on the zip code of the delivery location and the date of delivery, the system may auto calculate which items or products from the company are capable of being delivered to the customer by the specified delivery date. Specifically, for every item in stock associated with the company, the optimized offer presentation tool may calculate whether the production time and delivery time would result in the item at the delivery location before the user specified delivery date. The system may perform this calculation for all of the various production time options, for example, standard production, rush production, expedited production. In addition, the system may perform this calculation for all of the various shipment methods, for example, ground transit, 3-day air transit, 2-day air transit, and 1-day air transit.

The optimized offer presentation tool may provide at least one price optimized option for each of a plurality of items. The order placement tool is responsive to a user input to place an order from amongst the at least one price optimized option provided by the optimized offer presentation tool.

Further, the system may provide price optimized options for all of the various quantities of all of the plurality of items. Alternatively, the system may further include a quantity selection tool responsive to a user input to select a quantity of an item, wherein the optimized offer presentation tool is responsive to the quantity selection tool in providing at least one price optimized option.

Of course, instead of the system calculating every possible quantity of every possible product, the customer may be able to narrow the search by specifying the number of products, the type of products, as well as the desired shipping method and production schedule.

The system may further include a search capability related to product decoration techniques. For example, the product decoration techniques include imprint, embroidery, laser engravings, deboss, full color, and blank. For example, when a user selects imprint as the product decoration technique, the user may further narrow his or her search based on the number of colors used in the imprint.

The price optimized options may be presented such that the top five or ten results, based on the number of matches, are displayed. In addition, the results may be filtered using an accordion-like display. For example, a user may select a heading in the accordion display to either expand or collapse various results. In some circumstances, the results may be presented when a user hovers the mouse over a user selection, for example, in a quick view format. By further selecting the item, the application may display the full results.

The price optimized options may be presented with at least two check boxes to further sort or filter the results. For example, a user may have an option of sorting the results in ascending price, descending price, or by the quantity of items. If the user selects to sort based on ascending price, the first entry listed will be the least expensive and the last entry will be the most expensive. The user may also select a price cap to further narrow the search results. For example, the user may select a low price facet of one dollar such that products equal or greater than one dollar are displayed to the user. In another example, the user may select a high price cap of five dollars and a quantity of products of 50. In such case, the system may return results for products that are available at a quantity of 50 and that have a price at or below five dollars.

The user may further narrow search results based on product color. For example, the optimized offer presentation tool may display a small swatch of colors with associated labels. The user may select at least one color for the optimized offer presentation tool to limit the results to those products containing the selected color.

The products may also be searched based on whether the product is on sale, in stock, free setup, free shipment, made in the USA, and/or eco-friendly. In addition, the price optimized options may be filtered based on the brand of the product or the category of the product (e.g., apparel, women's apparel, beverage product, type of beverage product, etc.). In addition, the optimized offer presentation tool may narrow the search results based on the size and material of the product. For example, the size of the apparel may be selected by the user, the size of the beverage container, and/or the type of material of the product.

It should be noted that various changes and modifications to the presently preferred embodiments described herein will be apparent to those skilled in the art. Such changes and modifications may be made without departing from the spirit and scope of the present invention and without diminishing its attendant advantages.

What is claimed:

1. An ecommerce cost optimization system for agilely delivering customized goods comprising:
one or more computers configured with:
a display component for displaying information identifying an item;
a display component responsive to a user input for ordering customization of the item and then selecting the quantity of customized items desired;
a delivery location selection tool responsive to a user input to set at least one selected delivery location;
a delivery date selection tool responsive to a user input to set at least one selected delivery date;
an optimized offer presentation tool responsive to the delivery date selection tool and the delivery location selection tool, that, automatically in response to the selected delivery date, the quantity of items selected, the customization ordered and the selected delivery location, provides at least one price optimized option through the display component, wherein the at least one price optimized option is automatically selected from at least one combinations of one or more item customization, quantity, production schedules and possible manipulations of the production schedules, courier delivery schedules and one or more delivery options, wherein each of the combinations meets the selected delivery date and the selected delivery location, wherein the optimized offer presentation tool provides at least one price optimized option for each of a plurality of items; and
an order placement tool responsive to a user input to place an order from amongst the at least one price optimized option provided by the optimized offer presentation tool; and
an order fulfillment system for receiving the order placed, securing the quantity of items selected, customizing the items as ordered and delivering the customized items at the selected optimized option.

2. The ecommerce cost optimization system of claim 1 further comprising a quantity selection tool responsive to a user input to select a quantity of an item, wherein the optimized offer presentation tool is responsive to the quantity selection tool in providing at least one price optimized option.

3. The ecommerce cost optimization system of claim 1 further including an alternative offer presentation tool that provides, through the display component, at least one alternative option to the at least one price optimized option and further wherein the order placement tool is responsive to a user input to place an order from amongst the at least one price optimized option and the at least one alternative option.

4. The ecommerce cost optimization system of claim 3 wherein the at least one alternative option includes an alternative option based on a different delivery location compared to the selected delivery location.

5. The ecommerce cost optimization system of claim 3 wherein the at least one alternative option includes an alternative option based on a later delivery date than the selected delivery date.

6. A method of providing an optimized offer for non-stock customized- item goods transactions through an ecommerce application embodied on a computer-readable medium, the application being executed by at least one computer, including the steps of:
providing a component for identifying an item and being responsive to a user input for ordering customization of the item and then selecting the quantity of customized items desired, the component undertaking to check inventory and determine time and options for customization so as to create customization information;
providing an order placement mechanism including a delivery date selection tool, a delivery location selection tool, and an order placement tool;
receiving a user selection including a selected delivery date and a selected delivery location and customization information;
automatically, in response to receiving the selected delivery date, the customization information and selected delivery location, determining, by an optimized offer presentation tool, a price and date optimized offer, based on analysis of the all possible combinations of a production schedule and a courier delivery schedules, for each of the plurality of items to be delivered to the selected delivery location; and
providing the user with at least one price optimized offer based on the selected delivery date and selected delivery location.

7. The method of claim 5 wherein at least one price optimized offer is provided for each of a plurality of quantities of an item.

8. The method of claim 5 further including the step of providing at least one alternative option to the at least one price optimized offer.

9. The method of claim 8 wherein the at least one alternative option is based on a different delivery location than the selected delivery location.

10. The method of claim 8 wherein the at least one alternative option is based on a later delivery date compared to the selected delivery date.

11. The method of claim 8 further including the step of receiving a user selected order from amongst the at least one price optimized offer and the at least one alternative option.
